(19) United States
(12) Patent Application Publication
(10) Pub. No.: US 2024/0212409 A1
(43) Pub. Date: Jun. 27, 2024

(54) PAPER SHEET PROCESSING DEVICE

(71) Applicant: GLORY LTD., Himeji-shi (JP)

(72) Inventor: Yoshikatsu MIZUSHIMA, Himeji-shi (JP)

(73) Assignee: GLORY LTD., Himeji-shi (JP)

(21) Appl. No.: 18/597,266

(22) Filed: Mar. 6, 2024

Related U.S. Application Data
(63) Continuation of application No. 16/982,209, filed on Sep. 18, 2020.

(30) Foreign Application Priority Data
Mar. 26, 2018 (JP) 2018-057807

(51) Int. Cl. G07D 11/00; E05G 1/02; G07D 11/12

(52) U.S. Cl. CPC G07D 11/009; E05G 1/02; G07D 11/12; G07D 2211/00

(57) ABSTRACT

The present invention comprises: a depositing section; a withdrawal section; a first storage unit which is installed within a storage housing that is lockable, the first storage unit being used in at least one of depositing processing of the sheet and withdrawal processing of the sheet; an attachment section which detachably attaches a second storage unit to an outside of the storage housing, the second storage unit being used in at least one of the depositing processing and the withdrawal processing and storing the sheet in a state of being isolated from an outside of the second storage unit; a transport unit which transports the sheet among the depositing section, the withdrawal section, the first storage unit, and the second storage unit; and a control section which controls the transport unit to perform at least one of the above two processing.

### CROSS-REFERENCE TO RELATED APPLICATIONS

The present application is a Continuation of U.S. patent application Ser. No. 16/982,209, filed on Sep. 18, 2020, which claims priority under 35 U.S.C. § 371 to International Patent Application No. PCT/JP2019/012321, filed Mar. 25, 2019, which claims priority to and the benefit of Japanese Patent Application No. 2018-057807, filed on Mar. 26, 2018. The contents of these applications are hereby incorporated by reference in their entireties.

### TECHNICAL FIELD

The present invention relates to a sheet processing apparatus.

### BACKGROUND ART

Patent Literature (hereinafter, referred to as “PTL”) 1 discloses an outer stacking unit in which stacked money is removable directly from the outside of a housing. Further, PTL 1 describes that even in a case where a large amount of money is deposited or withdrawn, transporting the deposited or withdrawn money to the outer stacking unit makes it possible to prevent an inner stacking unit from becoming full and depositing or withdrawal processing from being interrupted.

Further, PTL 2 discloses bypassed depositing processing in which in depositing processing, a banknote placed into an inlet is dispensed to an outlet, while being accepted as a deposited banknote, and the dispensed banknote is managed outside a money processing apparatus. Further, PTL 2 discloses bypassed withdrawal processing in which in withdrawal processing, the banknote managed outside the money processing apparatus is placed into the inlet, and the placed banknote is dispensed to the outlet, while being accepted as a withdrawn banknote.

### CITATION LIST

### Patent Literature

PTL 1

WO 2010-049968

PTL 2

Japanese Patent Application Laid-Open No. 2013-37575

### SUMMARY OF INVENTION

### Technical Problem

In PTLs 1 and 2, however, there is a problem in terms of security as the banknote to be processed in the depositing processing or the withdrawal processing is managed outside the apparatus.

An object of the present invention is therefore to provide a technique to improve security of banknote management.

### Solution to Problem

A sheet processing apparatus according to the present invention comprises: a depositing section into which a sheet is placed; a withdrawal section to which a sheet is dispensed; a first storage unit which is installed within a storage housing that is lockable, the first storage unit being used in at least one of depositing processing of the sheet placed into the depositing section and withdrawal processing of the sheet to be dispensed to the withdrawal section, the first storage unit storing a sheet; an attachment section which detachably attaches a second storage unit to an outside of the storage housing, the second storage unit being used in at least one of the depositing processing and the withdrawal processing and storing a sheet in a state of being isolated from an outside of the second storage unit; a transport unit which transports the sheet among the depositing section, the withdrawal section, the first storage unit, and the second storage unit; and a control section which controls the transport unit to perform at least one of the depositing processing and the withdrawal processing.

### Advantageous Effects of Invention

According to the present invention, it is possible to improve security of banknote management.

### BRIEF DESCRIPTION OF DRAWINGS

FIG. 1 illustrates a banknote processing apparatus according to an embodiment of the present invention;

FIG. 2 illustrates the banknote processing apparatus when an attachable/detachable storage unit is detached;

FIG. 3 illustrates an example of a banknote transport path in first depositing processing;

FIG. 4 illustrates an example of a banknote transport path in a case where second depositing processing is permitted;

FIG. 5 illustrates an example of a banknote transport path in first withdrawal processing;

FIG. 6 illustrates an example of a banknote transport path in second withdrawal processing; and

FIG. 7 is a diagram describing an example of reconciliation processing.

### DESCRIPTION OF EMBODIMENTS

Hereinafter, the present invention will be described in detail with reference to the accompanying drawings. Note that, in the following description, the “front” of a sheet processing apparatus means a side provided with an opening for performing at least one operation of sheet placement and sheet discharge. Further, the “left” of the sheet processing apparatus means the left side toward the side provided with the opening, and the “right” of the sheet processing apparatus means toward the side provided with the opening.

Hereinafter, an example in which the sheet processing apparatus is applied to a banknote processing apparatus will be described. In this case, a “reject banknote” refers to a banknote that cannot be a processing target for predetermined processing. Examples of the “reject banknote” include a sheet that is not a banknote, and a banknote that passes through a recognition unit to be described later in a skew state or in a multi-feed state and therefore cannot be correctly recognized by the recognition unit. A “fit note” refers to a banknote with relatively little stain, tear, and the like, and an “unfit note” refers to a banknote with a relatively large amount of stain, tear, and the like.

### (1) Configuration of Banknote Processing Apparatus

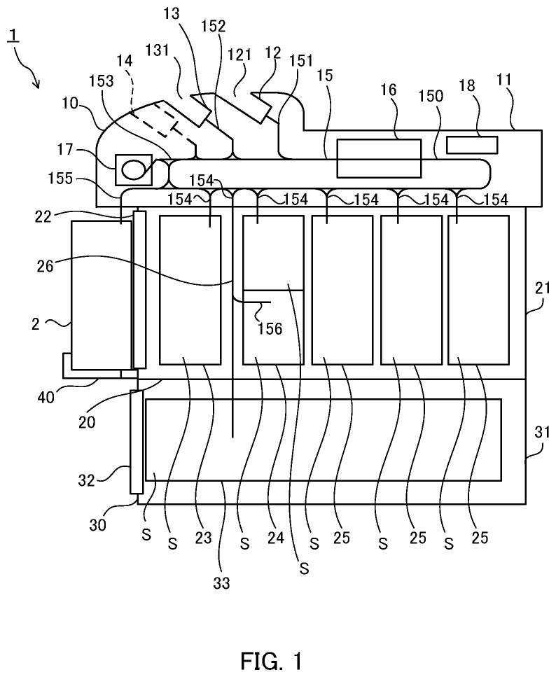

FIG. 1 illustrates a banknote processing apparatus 1 according to an embodiment of the present invention. In FIG. 1, the left side is a front portion of the banknote processing apparatus 1, and the right side is a rear portion of the banknote processing apparatus 1. Further, FIG. 1 also illustrates an attachable/detachable storage unit 2. The banknote processing apparatus 1 is, for example, installed at a teller counter of a bank and is used by a teller.

The banknote processing apparatus 1 is a banknote depositing and dispensing machine to/from which a banknote as a sheet is deposited/withdrawn. The banknote processing apparatus 1 comprises a processing section 10, a storage housing 20 provided below the processing section 10, and a second storage housing 30 provided under the storage housing 20. The processing section 10 can be drawn forward with respect to the storage housing 20 and the second storage housing 30.

The processing section 10 is surrounded by an upper housing 11. An inlet (opening) 121 and an outlet (opening) 131 are provided in a front portion of the upper housing 11, that is, in a front portion of the processing section 10. A transport unit 15, a recognition unit 16, a temporary storage section 17, and a control section 18 are disposed within the upper housing 11, that is, within the processing section 10. The control section 18 may be disposed within the storage housing 20 or the second storage housing 30.

A banknote feeding mechanism (not illustrated) that feeds out banknotes one by one to the transport unit 15 in a predetermined cycle is disposed near the inlet 121. The inlet 121 and the banknote feeding mechanism configure a depositing section 12.

A stacking mechanism (not illustrated) that stacks banknotes is disposed near the outlet 131. The outlet 131 and the stacking mechanism configure a withdrawal section 13. A second withdrawal section 14 having the same configuration as that of the withdrawal section 13 may be provided next to the withdrawal section 13 as needed.

Note that, the front portion of the processing section 10 may be provided with only one of the depositing section 12 and the withdrawal section 13 as needed. Further, the front portion of the processing section 10 may be provided with a depositing and withdrawal section. For example, the front portion of the processing section 10 may be provided with an opening through which both the depositing and withdrawal of a banknote are performed, and a banknote feeding mechanism and a stacking mechanism may be disposed around the opening.

The transport unit 15 transports a banknote at a predetermined transport speed. The transport unit 15 is configured with a belt mechanism and a roller mechanism for transporting the banknote. The transport unit 15 comprises a loop-shaped transport path 150 that enables the banknote to be transported bi-directionally, and a first diversion path 151, a second diversion path 152, a third diversion path 153, a fourth diversion path 154, and a fifth diversion path 155 that diverge from the loop-shaped transport path 150.

The first diversion path 151 connects the loop-shaped transport path 150 and the depositing section 12. The second diversion path 152 connects the loop-shaped transport path 150 and the withdrawal section 13. The third diversion path 153 connects the loop-shaped transport path 150 and the temporary storage section 17. The fourth diversion path 154 connects the loop-shaped transport path 150 and the storage housing 20, and also connects the loop-shaped transport path 150 and the second storage housing 30. The fifth diversion path 155 connects the loop-shaped transport path 150 and the attachable/detachable storage unit 2 to be described later.

The recognition unit 16 comprises a sensor such as an image sensor, an optical sensor and a magnetic sensor, and recognizes authenticity, denomination, fitness, and the like of the banknote transported by the transport unit 15.

The temporary storage section 17 temporarily stores banknotes. The temporary storage section 17 takes in and stores the banknotes one by one, and feeds out the stored banknotes one by one. The temporary storage section 17 is configured with, for example, a winding-type storage unit in which a plurality of banknotes is stored in a state of being wound around a rotating body. The temporary storage section 17 may be configured with a lamination-type storage unit in which a plurality of banknotes is stored in a state of being laminated.

The control section 18 comprises at least a central processing unit (CPU) and a memory. The control section 18 controls each configurations via the transport unit 15 and the configurations configuring the banknote processing apparatus 1 such that a banknote is transported among the depositing section 12, the withdrawal section 13, the temporary storage section 17, the storage housing 20, the second storage housing 30, and the attachable/detachable storage unit 2 to be described later.

The storage housing 20 can be configured with, for example, a safe, forms a lower housing 21, and comprises, in a front portion thereof, a storage housing door 22 that is lockable. Note that, the “storage housing door” in the present specification collectively refer to members capable of closing an opening section comprised by the lower housing 21. Accordingly, examples of the “storage housing door” include a door attached to the lower housing 21 via a hinge, a sliding door slidable along the lower housing 21, a plate member capable of coming into contact with or being separated from the lower housing 21, and the like.

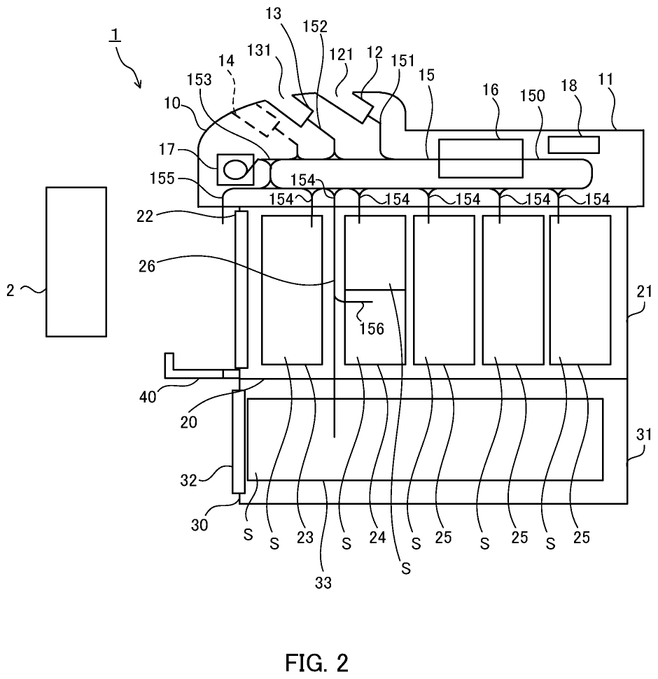

The storage housing door 22 can be opened from a front portion of the storage housing 20 when the attachable/detachable storage unit 2 is detached from the attachment section 40 (for example, see FIG. 2). Provision of the storage housing door 22 in the front portion of the storage housing 20 makes it easy for a person who operates the banknote processing apparatus 1 from the front to access the interior of the storage housing 20.

The storage housing 20 comprises, in order from the front portion, one multipurpose storage unit 23, one first storage unit 24, and three second storage units 25 disposed therein. Further, a vertical transport path 26 is disposed between the multipurpose storage unit 23 and the first storage unit 24.

The multipurpose storage unit 23 comprises a storage area S of lamination type in which a plurality of banknotes is stored in a state of being laminated. The multipurpose storage unit 23 is a banknote storage unit used for various purposes, and is used, for example, for storing an overflow banknote, a withdrawal reject banknote, a banknote left behind, a counterfeit note, and a suspect note. Further, the multipurpose storage unit 23 may also be used for the same purpose as that of the second storage unit 25.

The overflow banknote is a banknote that cannot be stored in a storage unit (the first storage unit 24 or the second storage unit 25) that is to store the banknote because the storage unit becomes full. Further, the withdrawal reject banknote is, among banknotes fed out from the first storage unit 24 or the second storage unit 25 when the withdrawal processing of the banknotes is performed, a banknote that cannot be recognized as normal by the recognition unit 16 due to transport abnormality such as skewing and therefore cannot be withdrawn. Further, the banknote left behind is a banknote that is once withdrawn to the withdrawal section 13, but then has not been taken out from the withdrawal section 13 for a predetermined time.

The first storage unit 24 comprises two storage areas S arranged vertically. The storage area S on the upper side is connected to the fourth diversion path 154, and the storage area S on the lower side is connected to a sixth diversion path 156 comprised by the vertical transport path 26. These two storage areas S are lamination-type storage areas in which a plurality of banknotes is stored in a state of being laminated, or winding-type storage areas in which a plurality of banknotes is stored in a state of being wound around a rotating body. In these storage areas S, specific kinds of banknotes, among banknotes sorted by authenticity, fitness, denomination, and the like, are stored. Instead of the first storage unit 24, two storage units each of which comprises a storage area S may be disposed so as to be stacked vertically.

The second storage unit 25 comprises one storage area S connected to the fourth diversion path 154. The storage area S is a lamination-type storage area in which a plurality of banknotes is stored in a state of being laminated. In the storage area S, specific kinds of banknotes, among banknote sorted by authenticity, fitness, denomination, and the like, are stored.

The vertical transport path 26 connects the fourth diversion path 154 and a collection section 33 disposed within the second storage housing 30.

The second storage housing 30 can be configured with, for example, a safe, forms a bottom housing 31, and comprises, in a front portion thereof, a storage housing door 32 that is lockable. Further, the second storage housing 30 comprises the collection section 33 therein. The collection section 33 comprises a storage area S in which, of banknotes deposited from the depositing section 12 and banknotes stored in the storage housing 20, a banknote to be collected is stored. After the banknote to be collected is stored therein, the banknote is collected from the inside of the collection section 33 by a collection worker. Alternatively, after the banknote to be collected is stored therein, the collection section 33 is detached from the banknote processing apparatus 1 by the collection worker and is collected together with the banknote. Then, a collection section 33 that is empty is attached instead.

An outside of the storage housing 20 is provided with the attachment section 40 for attaching the attachable/detachable storage unit 2 to the banknote processing apparatus 1. The outside of the storage housing 20 is, for example, an outer surface of the storage housing 20. The outer surface of the storage housing 20 is an outer surface of the storage housing 20 that is accessible without unlocking the storage housing door 22 that is locked, and specifically is an outer surface of the lower housing 21 or an outer surface of the storage housing door 22. More specifically, the attachment section 40 is provided on a front surface of the storage housing 20 as illustrated in FIGS. 1 to 7. The attachment section 40 may detachably attach the attachable/detachable storage unit 2 to the outside of the storage housing 20, and may be provided on a rear surface of the storage housing 20. Further, the attachment section 40 may be provided on a front surface, a rear surface or an upper surface of the processing section 10. Further, the attachment section 40 may be provided on a front surface or a rear surface of the second storage housing 30.

The attachment section 40 comprises a terminal (not illustrated) for supplying at least one of electric power and a control signal from the control section 18 to the attachable/detachable storage unit 2, and a terminal cover (not illustrated) covering the terminal. The terminal of the attachment section 40 is outside the storage housing 20 and is therefore easily soiled. However, it is possible to prevent the terminal from being soiled by providing the terminal cover. Further, the attachable/detachable storage unit 2 comprises a terminal (not illustrated) that is connected to the terminal comprised by the attachment section 40.

The attachment section 40 is capable of connecting a storage area S within the attachable/detachable storage unit 2 and the fifth diversion path 155, and has a shape and a structure that are not limited as long as the attachment section 40 is capable of supplying at least one of the electric power and the control signal to the attachable/detachable storage unit 2 via the terminal. For example, the attachment section 40 may have a structure of supporting the attachable/detachable storage unit 2 from below, or may have a structure of sandwiching the attachable/detachable storage unit 2 from above and below or from left and right. For example, the attachment section 40 may be provided on a lower surface of the front portion of the processing section 10 and may have a structure of suspending the attachable/detachable storage unit 2 to the front surface of the storage housing 20.

Note that, the terminal cover preferably has a mechanism of automatically opening and closing in cooperation with a part of the attachable/detachable storage unit 2 in accordance with attachment of the attachable/detachable storage unit 2 to the attachment section 40 or detachment of the attachable/detachable storage unit 2 from the attachment section 40. Since there are a variety of publicly known opening and closing mechanisms as such, any opening and closing mechanism can be employed therefrom.

The attachable/detachable storage unit 2 has, for example, a cuboid outer shape, and comprises the storage area S therein. The storage area S is a lamination-type storage area in which a plurality of banknotes is stored in a state of being laminated or a winding-type storage area in which a plurality of banknotes is stored in a state of being wound around a rotating body. The attachable/detachable storage unit 2 stores a banknote in the storage area S, and comprises a driving mechanism (not illustrated) comprising a motor or the like for discharging the banknote outside the storage area S. Further, the attachable/detachable storage unit 2 may not comprise the driving mechanism. In such a case, the banknote processing apparatus 1 may comprise the driving mechanism to transmit a driving to the attachable/detachable storage unit 2 that is attached to the banknote processing apparatus 1.

The attachable/detachable storage unit 2 stores a banknote in a state of being isolated from an outside of the attachable/detachable storage unit 2. For example, the attachable/detachable storage unit 2 comprises an opening only in a portion connected to the fifth diversion path 155, and prevents a banknote in the storage area S from being touched by an operator or the like. The attachable/detachable storage unit 2 comprises a door with a key, and the operator or the like can take out the banknote in the storage area S or storing a banknote in the storage area S by opening the door.

FIG. 2 illustrates the banknote processing apparatus 1 when the attachable/detachable storage unit 2 is detached. FIG. 2 illustrates the banknote processing apparatus 1 depicted in FIG. 1. As illustrated in FIG. 2, the attachable/detachable storage unit 2 can be detached from the attachment section 40. That is, a banknote stored in the attachable/detachable storage unit 2 is managed within the attachable/detachable storage unit 2, is isolated from the outside of the attachable/detachable storage unit 2, and is managed in a state of not being exposed to the outside of the attachable/detachable storage unit 2.

### (2) Depositing Processing

A description will be given of the depositing processing. The depositing processing is processing in which a banknote placed into the depositing section 12 is fed out from the depositing section 12, the banknote transported by the transport unit 15 is recognized by the recognition unit 16, the amount of money of the banknote recognized as normal is calculated, the calculated amount of money is accepted as a deposited amount of money, and the banknote is stored within the banknote processing apparatus 1 including the attachable/detachable storage unit 2. Upon completion of the depositing processing, an inventory amount within the banknote processing apparatus 1 including the attachable/detachable storage unit 2 is updated based on the accepted amount of money. The inventory amount may be managed separately for each storage unit. Note that, the processing of accepting the calculated amount of money as the deposited amount of money may be referred to as “depositing acceptance”.

The depositing processing comprises two types of processing that are first depositing processing and second depositing processing. The first depositing processing and the second depositing processing are selected by instructions of the operator via an operation unit (not illustrated). Alternatively, the first depositing processing and the second depositing processing may be automatically selected based on the kinds and number of deposited banknotes. For example, the second depositing processing may be automatically selected when a denomination of a banknote to be deposited is a predetermined denomination (for example, one-dollar banknote). Further, the second depositing processing may be automatically selected when it is known in advance that the number of banknotes to be deposited is greater than a predetermined number. Further, the second depositing processing may be automatically selected when the number of banknotes stored the storage housing 20 or the second storage housing 30 is greater than a predetermined number. As will be described in detail below, the first depositing processing uses the storage units of the storage housing 20, and the second depositing processing uses the attachable/detachable storage unit 2. The second depositing processing may be referred to as bypassed depositing processing.

### (2-1) First Depositing Processing

The first depositing processing is processing of storing banknotes accepted as deposited banknotes in the storage units within the storage housing 20. The operator gives an instruction to permit the banknote processing apparatus 1 to perform only the first depositing processing or to prohibit the banknote processing apparatus 1 from performing the second depositing processing via the operation unit (not illustrated). The banknotes placed into the depositing section 12 are supplied to the recognition unit 16 via the first diversion path 151 and the loop-shaped transport path 150. The recognition unit 16 recognizes and counts the banknotes. The banknotes having passed through the recognition unit 16 are temporarily stored in the temporary storage section 17. On the other hand, the transport unit 15 dispenses a reject banknote to the withdrawal section 13. Note that, a reject banknote generated during the first depositing processing may be placed into the depositing section 12 again and be recognized by the recognition unit 16 again.

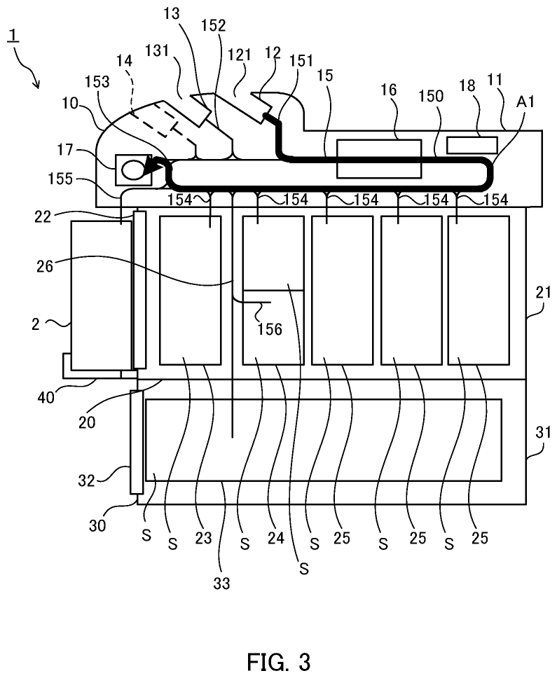

FIG. 3 illustrates an example of a banknote transport path in the first depositing processing. FIG. 3 illustrates the banknote processing apparatus 1 depicted in FIG. 1. As indicated by an arrow A1 in FIG. 3, a banknote placed into the depositing section 12 passes through the recognition unit 16 and is temporarily stored in the temporary storage section 17.

When the banknote temporarily stored in the temporary storage section 17 is accepted as a deposited banknote, the transport unit 15 stores the banknote temporarily stored in the temporary storage section 17 in the first storage unit 24 or the second storage unit 25, which is predetermined, according to a recognition result and a preset storage allocation. That is, each banknote is sorted by denomination and fitness and is stored in the storage housing 20. Note that, the storage allocation involves kinds of banknote set for each storage unit, and a banknote of the kinds corresponding to the storage allocation is stored in the storage unit. The kinds of banknote include at least one of denomination, fitness, and authenticity.

Note that, a banknote of a denomination whose allocation is not set in the first storage unit 24 and the second storage unit 25 and an unfit note are stored in the multipurpose storage unit 23 or the collection section 33. Further, an overflow banknote is also stored in the multipurpose storage unit 23 or the collection section 33.

In the first depositing processing, no banknote is stored in the attachable/detachable storage unit 2. Accordingly, the attachable/detachable storage unit 2 may be detached from the attachment section 40 in a state in which only the first depositing processing is permitted and the second depositing processing is prohibited.

### (2-2) Second Depositing Processing

The second depositing processing is processing of storing a banknote accepted as a deposited banknote in the attachable/detachable storage unit 2. The operator gives an instruction to permit the banknote processing apparatus 1 to perform the second depositing processing via the operation unit (not illustrated). Denominations of banknotes to be processed in the second depositing processing and to be stored in the attachable/detachable storage unit 2 are preset to the banknote processing apparatus 1. A banknote of a denomination other than the denominations to be processed in the second depositing processing is processed in the first depositing processing. The storage allocation of the attachable/detachable storage unit 2, which involves the denominations of banknotes to be processed in the second depositing processing and to be stored in the attachable/detachable storage unit 2, is set to the banknote processing apparatus 1 by the operator, for example, via the operation unit (not illustrated).

Examples of the denominations to be set to the attachable/detachable storage unit 2 include a denomination of banknotes that are deposited in large numbers. For example, there is a case where the number of banknotes of a given denomination (for example, one-dollar banknote) is overwhelmingly large among banknotes to be deposited in a given country. When the banknotes of such a denomination are stored in the first storage unit 24 and/or the second storage unit 25, the first storage unit 24 and/or the second storage unit 25 may frequently reach a state of full, and the depositing processing may be interrupted, for example. In this case, the given denomination described above (for example, one-dollar banknote) is set as that of banknotes to be stored in the attachable/detachable storage unit 2.

The banknote stored in the attachable/detachable storage unit 2 is also be treated as an accepted deposited banknote. The attachable/detachable storage unit 2 has a structure in which the banknote therein cannot be taken out without opening the door with a key, and ensures a certain degree of security. However, since the attachable/detachable storage unit 2 is freely detachably attached to the outside of the storage housing 20 that is lockable, the security of the attachable/detachable storage unit 2 is lower compared to that of the storage housing 20 that is supposed to have a safe structure. Further, the attachable/detachable storage unit 2 may be detached, with a banknote being stored therein, from the banknote processing apparatus 1 and be stored in a different location. Accordingly, the banknote stored in the attachable/detachable storage unit 2 is managed separately from the banknotes stored in the storage units within the storage housing 20 that is lockable. In other words, the banknote processing apparatus 1 separately manages information on the banknotes stored in storage units within the storage housing 20 that is lockable and information on the banknote stored in the attachable/detachable storage unit 2 outside the storage housing 20. Hereinafter, a denomination set as that of a banknote to be stored in the attachable/detachable storage unit 2 may be referred to as a particular denomination.

Note that, settings of denominations of banknotes to be processed in the second depositing processing and to be stored in the attachable/detachable storage unit 2 may be changed by the operator. In this case, a denomination of a high-value banknote may not be received as a denomination to be processed in the second depositing processing because a high-value banknote is desirably managed within the storage housing 20 or the second storage housing 30 that is configured with a safe or the like.

When the operator permits the banknote processing apparatus 1 to perform the second depositing processing via the operation unit (not illustrated) and banknotes are placed into the depositing section 12, the banknotes placed into the depositing section 12 pass through the first diversion path 151 and the loop-shaped transport path 150 to be supplied to the recognition unit 16. The recognition unit 16 recognizes and counts the banknotes. The banknotes having passed through the recognition unit 16 are not stored in the temporary storage section 17, but are stored in, for example, the first storage unit 24, the second storage unit 25, or the attachable/detachable storage unit 2 (direct depositing).

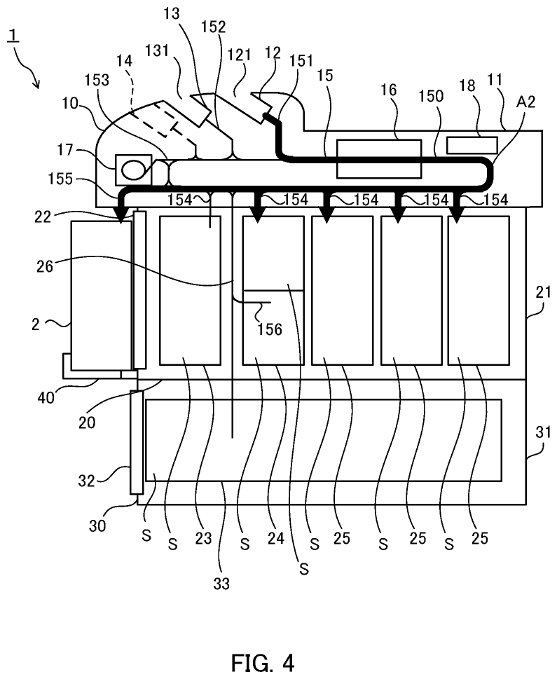

FIG. 4 illustrates an example of a banknote transport path in a case where the second depositing processing is permitted. FIG. 4 illustrates the banknote processing apparatus 1 depicted in FIG. 1. As indicated by an arrow A2 in FIG. 4, a banknote placed into the depositing section 12 passes through the recognition unit 16 and is stored in, for example, the first storage unit 24, the second storage unit 25, or the attachable/detachable storage unit 2.

The transport unit 15 stores the banknote having passed through the recognition unit 16 in the first storage unit 24, the second storage unit 25 or the attachable/detachable storage unit 2, which is predetermined, according to a recognition result and a preset storage allocation. That is, each banknote is sorted by denomination and fitness and is stored within the storage housing 20 or in the attachable/detachable storage unit 2 outside the storage housing 20.

Note that, a banknote of a denomination whose allocation is not set in the first storage unit 24, the second storage unit 25 and the attachable/detachable storage unit 2 and an unfit note are stored in the multipurpose storage unit 23 or the collection section 33. Further, an overflow banknote is also stored in the multipurpose storage unit 23 or the collection section 33.

On the other hand, the transport unit 15 dispenses a reject banknote to the withdrawal section 13. Note that, a reject banknote generated in a state in which the second depositing processing is permitted may be placed into the depositing section 12 again and be recognized by the recognition unit 16 again.

A description will be given of variations of the depositing processing of the banknote processing apparatus 1.

### Variation 1

In a case where depositing is cancelled prior to the depositing acceptance, the banknote processing apparatus 1 may feed out a deposited banknote from the first storage unit 24, the second storage unit 25 or the attachable/detachable storage unit 2 and return the banknote through the withdrawal section 13. Note that, the collection section 33 is incapable of feeding out a stored banknote. Accordingly, the banknote processing apparatus 1 has a function of receiving cancellation of depositing, and may cause a banknote stored in the collection section 33 to be temporarily stored in the temporary storage section 17 in a case where the cancellation of depositing is determined as valid. Then, in a case where the depositing is cancelled, the banknote processing apparatus 1 may dispense the banknote temporarily stored in the temporary storage section 17 to the withdrawal section 13. Alternatively, the banknote processing apparatus 1 may feed out a banknote of the same amount as that of the banknote stored in the collection section 33 from the first storage unit 24, the second storage unit 25 or the attachable/detachable storage unit 2, and return the fed-out banknote from the withdrawal section 13 without transporting the banknote to the temporary storage section 17.

### Variation 2

It is described above that in the second depositing processing, the banknote processing apparatus 1 does not temporarily store a banknote to be received as a deposited banknote in the temporary storage section 17, but stores the banknote in the attachable/detachable storage unit 2. However, the banknote processing apparatus 1 may temporarily store the banknote in the temporary storage section 17. The banknote processing apparatus 1 may transport the banknote in the temporary storage section 17 to the attachable/detachable storage unit 2 after the depositing acceptance.

Further, the banknote processing apparatus 1 may not temporarily store a banknote of a denomination, whose banknotes are stored in the attachable/detachable storage unit 2 and are managed outside the apparatus, in the temporary storage section 17, but may temporarily store the banknote in the attachable/detachable storage unit 2. The banknote processing apparatus 1 may temporarily store a banknote of another denomination in the temporary storage section 17, and store the banknote in the first storage unit 24 or the second storage unit 25 after the depositing acceptance.

### Variation 3

The banknote processing apparatus 1 may receive a plurality of denominations as those of banknotes to be managed outside the apparatus by storing the banknotes in the attachable/detachable storage unit 2. In other words, a plurality of denominations may be set as specific denominations. For example, the banknote processing apparatus 1 may set a one-dollar banknote and a five-dollar banknote as the denominations of banknotes to be managed outside the apparatus.

In a case where settings of a plurality of denominations are accepted, the banknote processing apparatus 1 may cause banknotes of the plurality of denominations to coexist and store the banknotes in the attachable/detachable storage unit 2.

Further, every denomination that can be handled by the banknote processing apparatus 1 may be set as the specific denominations, which corresponds to a state in which the banknote processing apparatus 1 is permitted to only perform the second depositing processing, or a state in which the banknote processing apparatus 1 is prohibited from performing the first depositing processing. In this case, a banknote whose depositing is received is stored in the attachable/detachable storage unit 2, a reject banknote is dispensed to the withdrawal section 13, and an overflow banknote is stored in the multipurpose storage unit 23 or the collection section 33.

Alternatively, the banknote processing apparatus 1 may store a banknote of a given denomination (for example, one-dollar banknote) in the attachable/detachable storage unit 2 and store a banknote of another denomination (for example, five-dollar banknote) in the temporary storage section 17. Further, after the attachable/detachable storage unit 2 storing the banknote of the given denomination is replaced with an attachable/detachable storage unit 2 storing a banknote of the other denomination, the banknote processing apparatus 1 may store the banknote of the other denomination stored in the temporary storage section 17 in the attachable/detachable storage unit 2.

Alternatively, the attachable/detachable storage unit 2 may be internally partitioned into a plurality of spaces. For example, the attachable/detachable storage unit 2 may comprise a plurality of storage areas S therein as illustrated in the multipurpose storage unit 23. The banknote processing apparatus 1 may store banknotes of different denominations in each of the plurality of spaces of the attachable/detachable storage unit 2.

### Variation 4

In a case where the attachable/detachable storage unit 2 becomes full in a state in which the second depositing processing is permitted, the banknote processing apparatus 1 may execute one of the following kinds of processing.
(1) The banknote processing apparatus 1 prohibits the second depositing processing. The banknote processing apparatus 1 permits the second depositing processing when an attachable/detachable storage unit 2 that becomes full is replaced with an attachable/detachable storage unit 2 that is not full. In other words, the banknote processing apparatus 1 prohibits the second depositing processing based on a banknote storage state of the attachable/detachable storage unit 2, and permits the second depositing processing again after the attachable/detachable storage unit 2 is replaced with an attachable/detachable storage unit 2 that is not full.
(2) The banknote processing apparatus 1 stores an excessive banknote, which cannot be stored in the attachable/detachable storage unit 2, in the collection section 33.
(3) The banknote processing apparatus 1 returns an excessive banknote through the withdrawal section 13 in the same manner as with a reject banknote. That is, the banknote processing apparatus 1 does not perform the depositing processing to the excessive banknote.
(4) The banknote processing apparatus 1 receives an excessive banknote as having been subjected to the depositing processing, and dispenses the excessive banknote to the outside of the banknote processing apparatus 1 (dispenses the excessive banknote to the withdrawal section 13). In this case, the banknote processing apparatus 1 may dispense the excessive banknote to the second withdrawal section 14 so as to distinguish the excessive banknote from a depositing reject banknote. The dispensed excessive banknote is manually managed outside the apparatus. This processing is equivalent to the conventional bypassed depositing processing and is defined as third depositing processing in the present specification. That is, the banknote processing apparatus 1 dispenses a banknote placed into the depositing section 12 to the withdrawal section 13 without transporting the banknote to any of the multipurpose storage unit 23, the first storage unit 24, and the second storage units 25 within the storage housing 20, the collection section 33 in the storage housing 30, and the attachable/detachable storage unit 2 outside the storage housing 20 and performs the depositing processing, based on the banknote storage state of the attachable/detachable storage unit 2.

### Variation 5

In a case where the attachable/detachable storage unit 2 is broken or is not attached to the attachment section 40, the banknote processing apparatus 1 may not receive the second depositing processing. Alternatively, the banknote processing apparatus 1 may execute the processing of (4) of Variation 4.

### Variation 6

The banknote processing apparatus 1 may not comprise the temporary storage section 17. In this case, a banknote to be subjected to the first depositing processing passes through the recognition unit 16, and is then stored in the multipurpose storage unit 23, the first storage unit 24, the second storage unit 25 or the collection section 33. A banknote to be subjected to the second depositing processing passes through the recognition unit 16, and is then stored in the multipurpose storage unit 23, the collection section 33 or the attachable/detachable storage unit 2.

### (3) Withdrawal Processing

A description will be given of the withdrawal processing. The withdrawal processing is processing of dispensing, based on a dispensing instruction, only a required number of banknotes of a required denomination outside the apparatus from the storage units within the banknote processing apparatus 1 including the attachable/detachable storage unit 2. In this case, the banknotes fed out from the storage units may be recognized by the recognition unit 16, and only banknotes recognized as normal may be withdrawn. Upon completion of the withdrawal processing, the inventory amount within the banknote processing apparatus 1 including the attachable/detachable storage unit 2 is updated. The inventory amount may be managed separately for each of the attachable/detachable storage unit 2, the first storage unit 24, and the second storage unit 25.

The withdrawal processing comprises two kinds of processing that are first withdrawal processing and second withdrawal processing. The first withdrawal processing and the second withdrawal processing are selected by instructions from the operator via the operation unit (not illustrated). As will be described in detail below, the first withdrawal processing uses the storage units of the storage housing 20, and the second withdrawal processing uses the attachable/detachable storage unit 2. The second withdrawal processing may be referred to as bypassed withdrawal processing.

### (3-1) First Withdrawal Processing

The first withdrawal processing is withdrawal processing of withdrawing a banknote, which is to be withdrawn, from the storage units within the storage housing 20. The operator gives an instruction to permit the banknote processing apparatus 1 to perform only the first withdrawal processing or to prohibit the banknote processing apparatus 1 from performing the second withdrawal processing via the operation unit (not illustrated). The banknote processing apparatus 1 feeds out a designated number of banknotes of a denomination designated at the time of the instruction of the withdrawal processing from, for example, the first storage unit 24 or the second storage unit 25. The transport unit 15 transports the fed-out banknotes to the recognition unit 16, and the recognition unit 16 recognizes the banknotes. Thereafter, banknotes recognized as normal are dispensed to the withdrawal section 13.

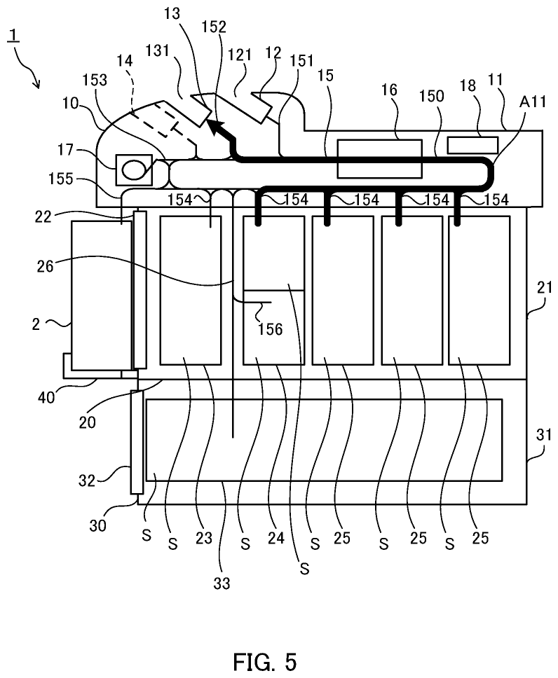

FIG. 5 illustrates an example of a banknote transport path in the first withdrawal processing. FIG. 5 illustrates the banknote processing apparatus 1 depicted in FIG. 1. As indicated by an arrow A11 in FIG. 5, a banknote stored in the first storage unit 24 or the second storage unit 25 passes through the recognition unit 16 and is dispensed to the withdrawal section 13.

A withdrawal reject banknote generated during the withdrawal processing is transported to the temporary storage section 17 and is stored therein. The banknote stored in the temporary storage section 17 is recognized again by the recognition unit 16 after completion of the withdrawal processing as needed, and is stored in the multipurpose storage unit 23, the first storage unit 24, the second storage unit 25 or the collection section 33.

In the first withdrawal processing, no banknote is dispensed from the attachable/detachable storage unit 2. Accordingly, the attachable/detachable storage unit 2 may be detached from the attachment section 40 in a state in which only the first withdrawal processing is permitted and the second withdrawal processing is prohibited.

### (3-2) Second Withdrawal Processing

The second withdrawal processing is processing of withdrawing a banknote, which is to be withdrawn, from the attachable/detachable storage unit 2. The operator gives an instruction to permit the banknote processing apparatus 1 to perform the second withdrawal processing via the operation unit (not illustrated). The banknote processing apparatus 1 feeds out a designated number of banknotes of a denomination designated at the time of the instruction of the withdrawal processing from, for example, the first storage unit 24, the second storage unit 25 or the attachable/detachable storage unit 2. A banknote of a denomination coinciding with the storage allocation of the first storage unit 24 or the second storage unit 25, among denominations designated at the time of the instruction of the withdrawal processing, is withdrawn by the first withdrawal processing. A banknote of a denomination coinciding with the storage allocation (specific denomination) of the attachable/detachable storage unit 2, among the denominations designated at the time of the instruction of the withdrawal processing, is withdrawn from the attachable/detachable storage unit 2 by the second withdrawal processing. The transport unit 15 transports the fed-out banknotes to the recognition unit 16, and the recognition unit 16 recognizes those banknotes. Thereafter, banknotes recognized as normal are dispensed to the withdrawal section 13.

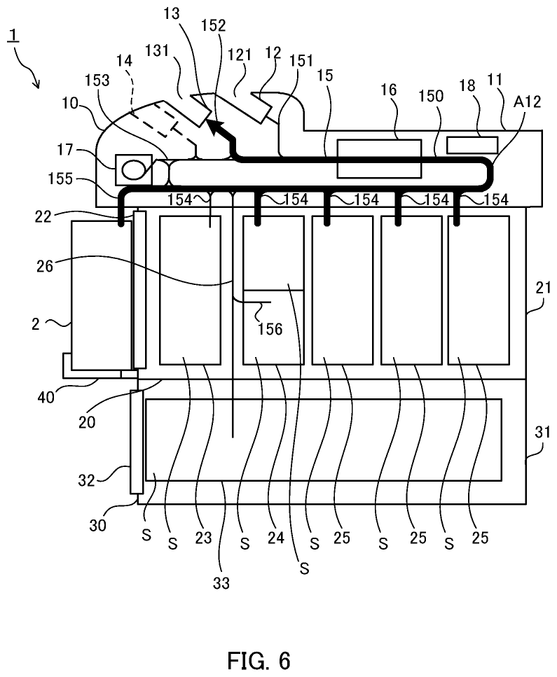

FIG. 6 illustrates an example of a banknote transport path in a case where the second withdrawal processing is permitted. FIG. 6 illustrates the banknote processing apparatus 1 depicted in FIG. 1. As indicated by an arrow A12 in FIG. 6, a banknote stored in the first storage unit 24 or the second storage unit 25 is dispensed via the recognition unit 16 to the withdrawal section 13 by the first withdrawal processing. A banknote stored in the attachable/detachable storage unit 2 is dispensed via the recognition unit 16 to the withdrawal section 13 by the second withdrawal processing.

A withdrawal reject banknote generated during the withdrawal processing is transported to the temporary storage section 17 and is stored therein. The banknote stored in the temporary storage section 17 is recognized again by the recognition unit 16 after completion of the withdrawal processing as needed, and is stored in the multipurpose storage unit 23, the first storage unit 24, the second storage unit 25, the attachable/detachable storage unit 2 or the collection section 33. A withdrawal reject banknote is stored in a storage unit in which the withdrawal reject banknote is stored at the beginning of the withdrawal processing. For example, a withdrawal reject banknote fed out from the first storage unit 24 by the first withdrawal processing is stored in the first storage unit 24. Further, a withdrawal reject banknote fed out from the attachable/detachable storage unit 2 by the second withdrawal processing is stored in the attachable/detachable storage unit 2. However, a reject banknote whose denomination cannot be recognized when the reject banknote is recognized again by the recognition unit 16 after completion of the withdrawal processing is stored in the multipurpose storage unit 23 or the collection section 33.

A description will be given of variations of the withdrawal processing of the banknote processing apparatus 1.

### Variation 1

The banknote processing apparatus 1 may not comprise the temporary storage section 17. In this case, the banknote processing apparatus 1 may dispense a withdrawal reject banknote to the second withdrawal section 14.

The withdrawal reject banknote dispensed to the second withdrawal section 14 may be manually managed as it is. Alternatively, the withdrawal reject banknote may be placed into the depositing section 12, the denomination thereof may be recognized by the recognition unit 16, and the withdrawal reject banknote may be returned to the first storage unit 24, the second storage unit 25, the collection section 33, or the attachable/detachable storage unit 2.

### Variation 2

The banknote processing apparatus 1 may transport a withdrawal reject banknote to the collection section 33 in a case where the temporary storage section 17 and the second withdrawal section 14 are not provided. In the case of a transport path structure as illustrated in FIG. 6, the banknote processing apparatus 1 needs to temporarily interrupt the banknote feeding operation from the attachable/detachable storage unit 2 to transport the withdrawal reject banknote to the recovery section 33.

### Variation 3

In the withdrawal processing, the banknote processing apparatus 1 may receive a plurality of denominations as denominations of banknotes to be withdrawn by the second withdrawal processing. In this case, the banknote processing apparatus 1 interrupts the second withdrawal processing when withdrawal from the attachable/detachable storage unit 2 storing a banknote of a given denomination ends. Then the banknote processing apparatus 1 resumes the second withdrawal processing after the attachable/detachable storage unit 2 storing the banknote of the given denomination is replaced with another attachable/detachable storage unit 2 storing a banknote of another denomination.

Alternatively, a plurality of denominations may be set as specific denominations. The attachable/detachable storage unit 2 may be internally partitioned into a plurality of spaces. Each of the plurality of spaces of the attachable/detachable storage unit 2 may store banknotes of different denominations, and the banknote processing apparatus 1 may withdraw a banknote of an appropriate denomination from the storage area of each space.

### Variation 4

In a case where the attachable/detachable storage unit 2 becomes empty in the middle of the second withdrawal processing, the banknote processing apparatus 1 may execute one of the following kinds of processing.
(1) The banknote processing apparatus 1 interrupts the second withdrawal processing. The banknote processing apparatus 1 resumes the second withdrawal processing when an attachable/detachable storage unit 2 that becomes empty is replaced with an attachable/detachable storage unit 2 comprising a banknote. That is, the banknote processing apparatus 1 stops the second withdrawal processing based on the banknote storage state of the attachable/detachable storage unit 2, and resumes the second withdrawal processing after the attachable/detachable storage unit 2 is replaced with an attachable/detachable storage unit 2 comprising a banknote.
(2) The banknote processing apparatus 1 ends (abnormal end) the second withdrawal processing.
(3) The banknote processing apparatus 1 switches to the conventional bypassed withdrawal processing (third withdrawal processing). For example, the banknote processing apparatus 1 receives a banknote, which is placed into the depositing section 12 and is manually managed with a drawer or the like, as having been subjected to the withdrawal processing, and dispenses the banknote to the withdrawal section 13. That is, the banknote processing apparatus 1 causes the banknote placed into the depositing section 12 to be recognized by the recognition unit 16, dispenses the number of banknotes of the denomination, which are to be withdrawn, to the withdrawal section 13 without transporting the banknote to any of the first storage unit 24 and the second storage units 25 within the storage housing 20, and the attachable/detachable storage unit 2 outside the storage housing 20. The amount of money of the banknotes withdrawn by the third withdrawal processing is subtracted from the manually managed inventory amount and performs the withdrawal processing, based on the banknote storage state of the attachable/detachable storage unit 2.

### Variation 5

In a case where the attachable/detachable storage unit 2 is broken or is not attached to the attachment section 40, the banknote processing apparatus 1 may not receive the second withdrawal processing. Alternatively, the banknote processing apparatus 1 may execute the processing of (3) of Variation 4.

### Variation 6

In the attachable/detachable storage unit 2 that feeds out a withdrawal reject banknote, the inventory amount may be uncertain. Accordingly, in a case where a withdrawal reject banknote is generated, the banknote processing apparatus 1 may perform reconciliation processing of the attachable/detachable storage unit 2 after completion of the withdrawal processing.

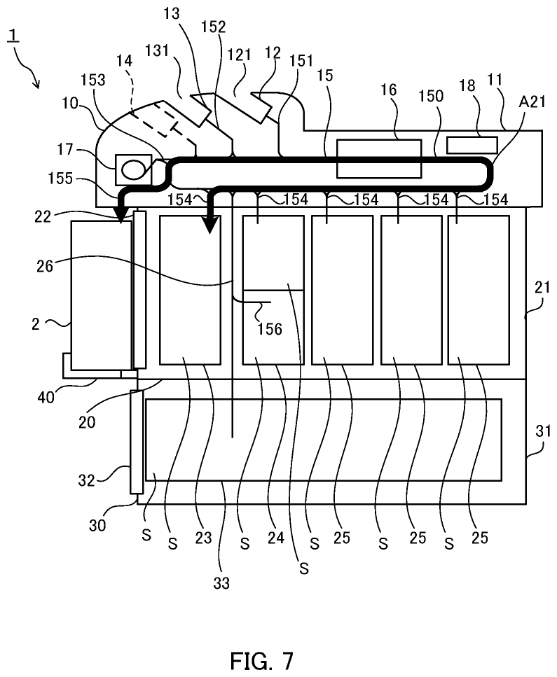

FIG. 7 is a diagram describing an example of the reconciliation processing. FIG. 7 illustrates the banknote processing apparatus 1 depicted in FIG. 1. In a case where a withdrawal reject banknote is generated, the banknote processing apparatus 1 transports all banknotes within the attachable/detachable storage unit 2 to the multipurpose storage unit 23 and returns the banknotes transported to the multipurpose storage unit 23 to the attachable/detachable storage unit 2 after completion of the withdrawal processing as indicated by an arrow A21 in FIG. 7. The banknote processing apparatus 1 causes the banknotes to pass through the recognition unit 16 on at least one of a forward path and a return paths to recognize the banknotes, and accepts the inventory amount of the attachable/detachable storage unit 2. In order to perform more rigorous reconciliation processing, the reconciliation processing may be started in a state in which no banknote is stored in the multipurpose storage unit 23. As a matter of fact, the reconciliation processing can also be performed in a state in which a banknote is stored in the multipurpose storage unit 23. Note that, the destination of the banknotes of the attachable/detachable storage unit 2 is not limited to the multipurpose storage unit 23. For example, the destination of the banknotes of the attachable/detachable storage unit 2 may be the first storage unit 24 or the second storage unit 25.

### Variation 7

In a case where the banknote processing apparatus 1 comprises both the temporary storage section 17 and the second withdrawal section 14, the banknote processing apparatus 1 may transport, among withdrawal reject banknotes, a normal banknote of a denomination, which is not to be withdrawn, to the temporary storage section 17, and transport a reject banknote resulted from an error in transport to the second withdrawal section 14.

After completion of the withdrawal processing, the operator adjusts a posture of a banknote dispensed to the second withdrawal section 14, and places the banknote into the depositing section 12. The banknote processing apparatus 1 returns the banknote placed into the depositing section 12, while confirming the denomination or the like of the banknote by the recognition unit 16, to the first storage unit 24, the second storage unit 25 or the attachable/detachable storage unit 2. Thus, elimination of errors in transport can be expected.

### Variation 8

In a case where a banknote of a specific denomination (for example, one-dollar banknote) is stored in one of the first storage unit 24 and the second storage unit 25 and further a banknote of a specific denomination (for example, one-dollar banknote) is stored in the attachable/detachable storage unit 2, and when withdrawal of the banknote of the specific denomination is instructed, the banknote processing apparatus 1 withdraws the banknote from one of the first storage unit 24 and the second storage unit 25 storing the banknote of the specific denomination in a state in which only the first withdrawal processing is permitted. Further, the banknote processing apparatus 1 withdraws the banknote from the attachable/detachable storage unit 2 in a state in which only the second withdrawal processing is permitted. That is, the banknote processing apparatus 1 may select whether to feed out the banknote of the specific denomination from the storage units stored within the storage housing 20 or from the attachable/detachable storage unit 2, depending on whether the first withdrawal processing and the second withdrawal processing are permitted or not by instructions of the operator.

As described above, the banknote processing apparatus 1 comprises the storage units within the storage housing 20 that is lockable. The storage units within the storage housing 20 that is lockable are used in the depositing processing of a banknote placed into the depositing section 12 and in the withdrawal processing of a banknote to be dispensed to the withdrawal section 13. Further, the banknote processing apparatus 1 comprises the attachment section 40 that detachably attaches the attachable/detachable storage unit 2 to the outside of the storage housing 20. The attachable/detachable storage unit 2 attached to the attachment section 40 stores a banknote in a state of being isolated from the outside of the attachable/detachable storage unit 2, and is used in the depositing processing and the withdrawal processing. Thus, it is possible for the banknote processing apparatus 1 to improve security of banknote management even though a banknote of a specific denomination can be managed outside the storage housing 20 having a safe structure. Examples of the banknote of the specific denomination include a banknote of a denomination to be expected to be deposited in large numbers and a banknote to be managed separately from a banknote of the storage housing 20 for some reason.

Note that, the first storage unit 24 and the second storage unit 25 may be used in at least one of the depositing processing (the first depositing processing and the second depositing processing) and the withdrawal processing (the first withdrawal processing and the second withdrawal processing). Further, the attachable/detachable storage unit 2 may be used in at least one of the depositing processing and the withdrawal processing. Further, the banknote processing apparatus 1 may have a function of at least one of the depositing processing (the first depositing processing and the second depositing processing) and the withdrawal processing (the first withdrawal processing and the second withdrawal processing).

Further, the attachable/detachable storage unit 2 may also be provided with a locking mechanism such that the attachable/detachable storage unit 2 cannot be freely detached from the attachment section 40. Thus, the banknote processing apparatus 1 is capable of further improving security of management of banknotes that are deposited in large numbers. Note that, the locking mechanism of the attachable/detachable storage unit 2 may have a security level lower than that of the locking of the storage housing door 22.

Further, the attachable/detachable storage unit 2 is in a state of being exposed to the outside as described above, but may be stored in a closed space. For example, a front portion of the attachable/detachable storage unit 2 is provided with an opening and closing door, and a closed space (a space isolated from the outside) storing the attachable/detachable storage unit 2 is formed between the opening and closing door and the storage housing door 22. The attachable/detachable storage unit 2 may be stored in a space between the opening and closing door and the storage housing door 22. Thus, the banknote processing apparatus 1 is capable of further improving security of banknote management in the attachable/detachable storage unit 2. Further, the opening and closing door may be provided with a locking mechanism having a security level lower than that of the locking of the storage housing door 22. Thus, the attachable/detachable storage unit 2 can be relatively freely detached.

Further, although it is described that the operator instructs whether the first depositing processing and the second depositing processing are permitted or not, the banknote processing apparatus 1 may be configured to permit only the first depositing processing in the normal state (in a case where there is no instruction from the operator), and to enable the second depositing processing to be executed when an instruction from the operator to permit the second depositing processing is received. Further, although it is described that the operator instructs whether the first withdrawal processing and the second withdrawal processing are permitted or not, the banknote processing apparatus 1 may be configured to execute only the first withdrawal processing in the normal state (in a case where there is no instruction from the operator), and to enable the second withdrawal processing to be executed when an instruction from the operator to permit the second withdrawal processing is received.

Further, the banknote processing apparatus 1 may comprise an outer stacking unit (an outer stacking unit storing banknotes in a state of not being isolated from the outside of the apparatus) that stacks banknotes recognized by the recognition unit 16 and that enables the stacked banknotes to be directly taken out from the outside of the apparatus. For example, the outer stacking unit may be provided on a rear upper surface of the upper housing 11 (for example, a portion above the recognition unit 16 and the control section 18 in FIG. 1). In the second withdrawal processing, the banknote processing apparatus 1 may dispense a banknote of a specific denomination to the outer stacking unit. Further, in the second withdrawal processing, the banknote processing apparatus 1 may dispense a banknote of a specific denomination to the withdrawal section 13. In this case, the second withdrawal processing may be stopped at the time when the number of banknotes dispensed to the withdrawal section 13 reaches a predetermined number, and the second withdrawal processing may be resumed after the banknotes dispensed to the withdrawal section 13 are removed. Such an embodiment makes it possible to easily address even a case where the number of banknotes to be withdrawn is large.

Further, the operation unit may be a key apparatus or a touch screen comprised by the banknote processing apparatus 1. Alternatively, the operation unit may be a keyboard or the like comprised by a terminal apparatus, such as a personal computer (PC), connected to the banknote processing apparatus 1. Alternatively, the operation unit may be a keyboard or the like comprised by a host apparatus, such as a server, connected to the banknote processing apparatus 1.

### Reference Signs List

1 Banknote processing apparatus
10 Processing section
11 Upper housing
12 Depositing section
121 Inlet (Opening)
13 Withdrawal section
131 Outlet (Opening)
14 Second withdrawal section
15 Transport unit
150 Loop-shaped transport path
151 First diversion path
152 Second diversion path
153 Third diversion path
154 Fourth diversion path
155 Fifth diversion path
156 Sixth diversion path
16 Recognition unit
17 Temporary storage section
18 Control section
20 Storage housing
21 Lower housing
22 Storage housing door
23 Multipurpose storage unit
24 First storage unit
25 Second storage unit
26 Vertical transport path
30 Second storage housing
31 Bottom housing
32 Second storage housing door
33 Collection section
40 Attachment section
2 Attachable/detachable storage unit
S Storage area

1. A banknote processing apparatus having a first cassette and a second cassette, each cassette stacking a banknote in one direction, the banknote processing apparatus comprising:
an input slot that accepts a banknote to take the banknote inside the banknote processing apparatus;
a conveyor that transports the banknote in the banknote processing apparatus;
a recognition sensor that recognizes the banknote transported by the conveyor;
an output slot that dispenses the banknote from inside the banknote processing apparatus;
an upper casing that includes the input slot, the conveyor, the recognition sensor, and the output slot;
a safe that is located below the upper casing and accommodates the first cassette;
a holder that is fixed outside the safe and detachably holds the second cassette; and
control circuitry,
wherein in a depositing processing between the input slot and the second cassette, the control circuitry controls the conveyor to transport the banknote from the input slot to the second cassette and updates an inventory amount of the banknote processing apparatus based on a deposit amount about the second cassette, and
wherein in a withdrawal processing between the second cassette and the output slot after the depositing processing, the control circuitry controls the conveyor to transport the banknote from the second cassette to the output slot and updates the inventory amount of the banknote processing apparatus based on a withdrawal amount about the second cassette.

2. The banknote processing apparatus according to claim 1,
wherein in the depositing processing, the control circuitry controls the conveyor to transport not a specific banknote but all banknotes accepted by the input slot from the input slot to the second cassette.

3. The banknote processing apparatus according to claim 1, further comprising a temporary tape storage that is located in the upper casing,
wherein in the depositing processing,
the control circuitry controls the conveyor to transport the banknote from the input slot to the temporary tape storage before transporting the banknote to the second cassette, and
the control circuitry controls the conveyor to transport the banknote from the temporary tape storage to the outlet slot based on a deposit cancellation command acquired by the control circuitry, or to transport the banknote from the temporary tape storage to the second cassette based on a deposit accept command acquired by the control circuitry.

4. A banknote processing apparatus having a first cassette and a second cassette, each cassette stacking a banknote in one direction, the banknote processing apparatus comprising:
an input slot that accepts a banknote to take the banknote inside the banknote processing apparatus;
a conveyor that transports the banknote in the banknote processing apparatus;
a recognition sensor that recognizes the banknote transported by the conveyor;
an output slot that dispenses the banknote from inside the banknote processing apparatus;
an upper casing that includes the input slot, the conveyor, the recognition sensor, and the output slot;
a safe that is located below the upper casing and accommodates the first cassette;
a holder that is fixed outside the safe and detachably holds the second cassette; and
control circuitry,
wherein in a depositing processing between the input slot and the second cassette, the control circuitry controls the conveyor to transport the banknote from the input slot to the second cassette and updates an inventory amount of the banknote processing apparatus based on a deposit amount about the second cassette.

5. The banknote processing apparatus according to claim 4,
wherein in the depositing processing, the control circuitry controls the conveyor to transport not a specific banknote but all banknotes accepted by the input slot from the input slot to the second cassette.

6. The banknote processing apparatus according to claim 5,
wherein in the depositing processing, the control circuitry controls the conveyor to transport not a specific banknote but all the banknotes accepted by the input slot from the input slot to not the first cassette but the second cassette.

7. The banknote processing apparatus according to claim 4,
wherein the control circuitry executes the depositing processing based on information about a number of banknotes accepted by the input slot, and the information is input by an operator.

8. The banknote processing apparatus according to claim 4,
wherein the control circuitry executes the depositing processing based on information about comparison of a number of banknotes accepted by the input slot with a number of banknotes stored in the safe.

9. A banknote processing apparatus having a first cassette and a second cassette, each cassette stacking a banknote in one direction, the banknote processing apparatus comprising:
an input slot that accepts a banknote to take the banknote inside the banknote processing apparatus;
a conveyor that transports the banknote in the banknote processing apparatus;
a recognition sensor that recognizes the banknote transported by the conveyor;
an output slot that dispenses the banknote from inside the banknote processing apparatus;
an upper casing that includes the input slot, the conveyor, the recognition sensor, and the output slot;
a safe that is located below the upper casing and accommodates the first cassette;
a holder that is fixed outside the safe and detachably holds the second cassette; and
control circuitry,
wherein in a withdrawal processing between the second cassette and the output slot, the control circuitry controls the conveyor to transport the banknotes from the second cassette to the output slot and updates an inventory amount of the banknote processing apparatus based on a withdrawal amount about the second cassette.

10. The banknote processing apparatus according to claim 9,
wherein the control circuitry interrupts the withdrawal processing when the second cassette becomes empty in the withdrawal processing, and
wherein after the second cassette is exchanged for another second cassette that stacks a banknote, the control circuitry restarts the withdrawal processing and controls the conveyor to transport the banknote from the other second cassette to the output slot and updates an inventory amount of the banknote processing apparatus based on a withdrawal amount about both the second cassette and the other second cassette.

11. The banknote processing apparatus according to claim 9,
wherein in a case where a target denomination of a banknote for the depositing processing accords with a denomination of a banknote stacked in the second cassette, the control circuitry allows the depositing processing and controls the conveyor to transport the banknote from the other second cassette to the output slot.
